(19) United States
(12) Patent Application Publication
(10) Pub. No.: US 2026/0238853 A1
(43) Pub. Date: Aug. 13, 2026

(54) METHODS, ARCHITECTURES, APPARATUSES AND SYSTEMS FOR ENERGY-SAVING VIDEO PROCESSING

(71) Applicant: DRNC Holdings, Inc., Wilmington, DE (US)

(72) Inventor: William REDMANN, Glendale, CA (US)

(21) Appl. No.: 19/154,262

(22) PCT Filed: Feb. 8, 2024
(86) PCT No.: PCT/US2024/014975

§ 371 Date: Aug. 6, 2025

Related U.S. Application Data
(60) Provisional application No. 63/444,790, filed on Feb. 10, 2023.

(51) Int. Cl. H04N 21/443; H04N 21/218; H04N 21/234; H04N 21/44

(52) U.S. Cl. CPC H04N 21/4436; H04N 21/218; H04N 21/23418; H04N 21/44008

(57) ABSTRACT

Procedures, methods, architectures, apparatuses, systems, devices, and computer program products for energy-saving video processing. A device includes a receiver configured to receive data indicative of a demand response status; at least one processor configured to receive information corresponding to a first video from a video source and generate a second video based on the first video, the second video having a having a first average picture level (APL) when the data indicates there is no demand response in progress and having a second APL that is less than the first APL when the data indicates there is a demand response event in progress; and, a video output configured to provide the second video to a display such that for displays whose power consumption is APL-dependent, power consumption is reduced during a demand response event.

### CROSS-REFERENCE TO RELATED APPLICATIONS

This application claims the benefit of U.S. Provisional Application No. 63/444,790, filed Feb. 10, 2023, which is incorporated herein by reference in its entirety.

### BACKGROUND

The present disclosure is generally directed to the fields of communications, software and encoding, including, for example, to methods, architectures, apparatuses, systems directed to energy-saving video processing.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1 is a system diagram illustrating an example of a video system according to an embodiment of the present principles;

FIG. 2 illustrates a block diagram for one example embodiment an end-user device according to the present principles;

FIGS. 3A and 3B illustrate flow charts of three related methods according to the present principles in different ways;

FIG. 4 illustrates a variety of examples of power-saving image processing according to the present principles;

FIG. 5 illustrates a block diagram of a video processing system comprising video source device of the present principles;

FIG. 6 is a flowchart for a method of video processing performed by video source device according to the present principles; and

FIG. 7 illustrates the relationship among corresponding portions of input and output video in various modes of operation according to the present principles.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

Most of the time, sufficient electric power is available in developed areas. However, in most of these places, there are occasional events where the quantity of available electric power is insufficient to meet the full demand. If unmanaged, this could cause widespread blackouts (i.e., the electric grid fails and electric power is interrupted), brownouts (i.e., a below-nominal delivery voltage is provided), or “load shedding” (i.e., segments of the grid are deliberately shut off in order to keep the remainder of the grid operational, often on a periodic basis often called “rolling blackouts”).

Techniques have been introduced where systems managing the grid signal a “demand response” (DR) event as a mechanism to forestall the more severe interruptions. The U.S. Federal Energy Regulatory Commission defines “demand response” as “changes in electric usage by demand-side resources from their normal consumption patterns in response to changes in the price of electricity over time, or to incentive payments designed to induce lower electricity use at times of high wholesale market prices or when system reliability is jeopardized.”

Typically, large scale power users, such as factories or large buildings (e.g., skyscrapers), are equipped with systems able to receive a DR signal and operate automatically, or even with manual intervention, to reduce their power consumption for the duration of the event. The reaction of such a system to a DR event could be to shut down energy-hungry processes (e.g., electric furnaces, large conveyor systems) or turn off or turn down less critical appliances (e.g., air conditioner thermostats could be raised a few degrees). In some cases, the DR signal is merely a change in pricing for electricity, and systems that can react quickly to price changes adapt accordingly.

Historically, there have been many systems developed to signal that the electric utility is under stress and that less power should be consumed. A drawback of early versions of these systems has been that they were not standardized or interoperable. More recently, standards that support broad interoperability have emerged, for example those promoted by the OpenADR Alliance (www.openadr.org). The Alliance has developed a collection of standards and certifications called Open Automated Demand Response (OpenADR™). These standards describe a Virtual Top Node (VTN) that behaves as a server to issue information related to the demand on the electric utility, including electricity prices; and a Virtual End Node (VEN) that is both a client to the VTN and part of an end-use control system that determines, based on information from the VTN, to what degree, if any, a reduction in energy usage is warranted. The end-use control system reacts accordingly, producing the reductions automatically when that is possible, or by signaling for manually instituted reductions where that is necessary.

One of the areas that can contribute to lowering power consumption, for example in response to a DR event, is the human activity of “watching TV” for which, by a rough estimate, the entire ecosystem consumes about 10% of global energy usage and, by some estimates, roughly half of this amount being attributed to video display devices. Fundamentally, it takes more energy to light up a pixel on a TV set than it does to broadcast the signal that tells the TV set which pixels to light up. This relationship is thought to be reversed for smaller displays such as smartphones, tablets, and laptops that rely on a video streaming infrastructure, but still, a substantial portion of the power directly consumed by the small device is that which drives its display. Thus, the amount of energy consumed by video display devices, in aggregate, is significant, but conventional video display devices have not been integrated into DR systems.

Of course, a video display could be plugged into a circuit that becomes selectably unpowered by an end-use control system based on a DR signal, along with whatever lights, heaters, or other devices were on the same circuit, but that is not a broadly viable solution. In for example the U.S., freedom of speech is a constitutionally guaranteed right, and imposing a requirement to allow a signal that blocks video communication could be subject to legal challenge. Further, many people turn to the TV or other screens for important information, for example regarding the DR event itself, and could thus experience difficulties accessing the information. Additionally, having video displays cut off could inconvenience members of society in other ways. A sports bar that loses its video displays will lose business, too. Children assigned to view an educational programming or citizens attempting to watch or participation in government meetings via local access channels, would be denied those resources if unable to watch them as they are being provided. Accordingly, depowering video displays is not a viable scheme to reduce power consumption upon demand.

As is well known, the power consumption of many kinds of video display is dependent on the brightness in the video image. Brightness can be expressed by a measure called Average Picture Level, APL. According to Charles Poynton, in his book Digital Video and HD: Algorithms and Interfaces, Second Edition (2012), the term “Average Picture Level” is “A historical term, now ambiguous:” with two distinct meanings: the first “Traditionally in media, APL is equivalent to average pixel level” and the second “a linear light measure unlike average pixel level. Properly termed average relative luminance (ARL). He then defines that “average pixel level is “The average of luma (Y′) throughout the image area of a frame, sequence, scene, or program” and says “Average pixel level is preferred to the historical term average picture level for disambiguation, to make clear that it is gamma-corrected pixel values (not their luminance or tristimulus equivalents) that are averaged. For average relative luminance he says, “The average of luminance (Y) throughout the entire image area of a frame, sequence, scene, or program. ARL is a linear-light measure (unlike average pixel level).”

Herein, the term “Average Picture Level” and its acronym “APL” are used to in a way that either of Poynton's two definitions is acceptable, as the term is always used in the context of comparing the brightness levels of an initial image to those of a processed image and whether the comparison finds that they are the same or reduced. Whether they are linear or gamma-corrected, the relationships relied on by the present principles are similar.

For example, in an emissive display having each pixel or subpixel independently controlled, having any pixel reduced in brightness or turned off will reduce the energy used to illuminate that pixel. The power consumption of such displays is dependent on the APL.

Similarly, a cathode ray tube (CRT) display produces light based on its beam current, which is modulated to render the image as it is swept in a raster across the CRT screen. Lower beam currents, corresponding to dimmer or black portions of the image, correspond to lower power usage. Another example is a plasma display, wherein each subpixel has its own separate beam current.

In another example, an LCD display can have a backlight divided into separately controlled zones. Each zone serves some subset of the display's pixels, and the zone is driven based on the peak brightness among the pixels or subpixels the zone serves. Reducing that peak brightness allows the zone to be correspondingly reduced in brightness, which corresponds to a reduction in the energy used to drive that zone. If the pixels or subpixels served by a zone are entirely black, the zone can even be turned off. Generally, the image savings for LCD displays can be greater for more finely divided backlights, i.e., those having many zones, and somewhat less for more coarsely divided backlights. When approaching the limit of a separate zone for each pixel, the power consumption approaches direct dependence on the APL.

In the other direction, in the limit of an LCD display having a monolithic (single zone) backlight that serves all the pixels, where such a backlight is modulated in brightness, but uniformly throughout, based on the brightest portion of the image, then an energy savings still results when at least the peak brightness, if not the overall brightness, of the image is reduced. Note that reducing the peak brightness, even if no other portion of the image is reduced in brightness, still reduces the APL. However, if the peak brightness remains unchanged, even when other processing of the video results in a lowered APL, the energy consumption of a monolithic backlight LCD display may in some cases remain unchanged.

It is noted that some displays may be completely unsuited to accrue an energy savings according to the present principles. For example, an LCD display having a monolithic (single zone) backlight that is set to a constant brightness, which is independent of the image being displayed. In this degenerate case, regardless of a reduced APL or reduced peak brightness in the video image, energy consumption will remain constant.

A main aspect of the present principles is directed to an end-user device that can react to a DR event by providing a video signal, based on an input signal, that can decrease power consumption of a display device rendering the video signal. The device could include the display, such as in a TV, but the display could be external, such as with a set-top box (STB).

As used herein, an STB could for example be a satellite receiver box, a cable television box, an over-the-top (OTT) dongle such as a Roku®, Fire TV™ by Amazon, or Chromecast™ device by Google. It should be understood that the present principles can also apply to other devices configured to be connected to an external display, such as for example video game consoles (e.g., Sony PlayStation™, Xbox™ and the like) and audio/video receivers (AVRs) that accept signals from a number of sources (e.g., other STBs) before a selected signal is delivered to an external display. Herein, these kinds of video devices are referred to generically as “video source device”.

As already described, the power consumption of many kinds of video display is dependent on the brightness in the video image. The relationship may depend on the APL, the peak brightness, or a more complicated function that may fall in between the APL and peak brightness. Thus, for many kinds of display, reduction in the peak brightness of a displayed image, or in many cases, merely a reduction in the APL, can produce a reduction in energy draw by the display, compared to the energy draw when showing the unaltered image.

Typically, an external media source is not connected directly to an image decoder and processor, though this is possible. More typically, the video signal gets to the image decoder and processor through a media selector. The media selector is configured to select a media source from among a plurality of sources. The media selector may include switching and/or tuning capabilities. The media selector may provide user interface capabilities to allow a user to control whatever switching and tuning capabilities are available.

Some media selectors are configured to switch among different inputs, e.g., multiple High-Definition Multimedia Interface (HDMI™), DisplayPort input ports, and/or analog video inputs. Some media selectors can switch among other sources, e.g., apps that might further select among different digital media streams, whether extracted from a file or obtained through a network. Some media selectors have a tuner configured to select among different channels in a terrestrial (over-the-air, OTA), satellite broadcast, or cable distribution. Some media selectors can access media directly from files (e.g., on an externally connected USB stick or hard drive, or an internal hard drive providing playback with a digital video recorder ‘DVR’ capability). Some media selectors can switch among various of these sources (e.g., HDMI, OTA, USB, DVR, etc.).

A device according to the present principles includes a demand response, DR, input module. In one embodiment, the DR input module implements a virtual end node (VEN) as specified in the OpenADR specifications. The DR input node is configured to receive demand response information and provide such information to a DR processor. The DR processor can be configured to determine, based on at least that information, whether a DR event is currently occurring. In this case, the DR processor may determine if, and possibly to what degree, the device should process an input video so that when the processed video is displayed, an energy usage by the display is expected to be reduced.

In some embodiments, the DR processor signals to an image decoder whether an energy usage reduction is to be effectuated, and optionally to what degree of reduction. The image decoder is configured to accept an input video signal, typically from the media selector. The video signal may be encoded and, as needed, decoded by the image decoder and processor.

In some embodiments, based on at least a reduction being called for, the image is reduced in scale by the decoder and image processor, relative to the video container (e.g., a frame buffer or logical pixel matrix having the dimension of the decoded, but unprocessed, image) and the rest of the video container is populated to represent black, such that when provided to the display, the image is shown but, as it is reduced in scale, only covers a portion of the display and the remainder of the display shows black. With the contribution of black around the image at reduced scale, the average picture level (APL) is lowered. The smaller the resulting image, the greater the reduction in APL. Note that a reduction in scale, absent other processing, may leave the peak brightness of the image unchanged, or only slightly reduced (e.g., where an image is such that all pixels having the peak brightness are blended as the processor scales the image with neighboring pixels having a lesser brightness, whereby the resulting output pixels are reduced from the peak).

In some embodiments, again based on at a reduction called for, the image retains the same scale, but is actually or effectively reduced in brightness. For example, the luminance value of at least some (e.g., each) pixel in the image is reduced. This lowers both the peak brightness of the image and the APL. Another example is to set certain pixels (e.g., alternate columns) in the video signal to black. When displayed on some of today's ultra-high resolution displays and observed from typical television viewing distances, the pixels set to black would not be individually visible as being black. This scheme does not reliably lower the peak brightness, as only some pixels are affected, but does lower the APL as long as the input image is not wholly black.

In some embodiments, both brightness reduction schemes are used, with brightness reduction and image scaling being applied in either order.

In some embodiments, the selected media may contain DR information, which can be provided to the DR input module. In some embodiments, DR information may be provided, possibly broadcast, via a connection, for example a network connection, or a wireless connection. In some embodiments the DR information may be provided as a file.

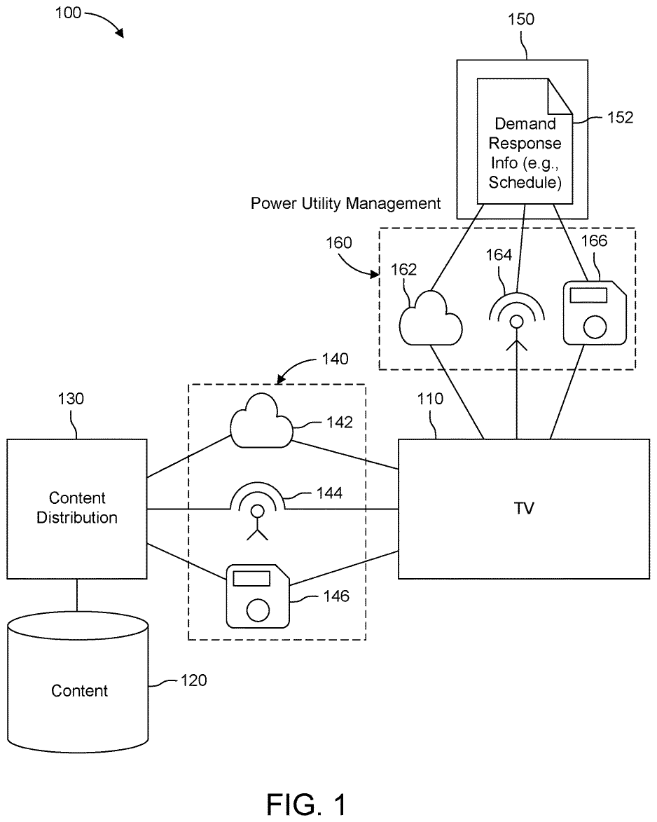

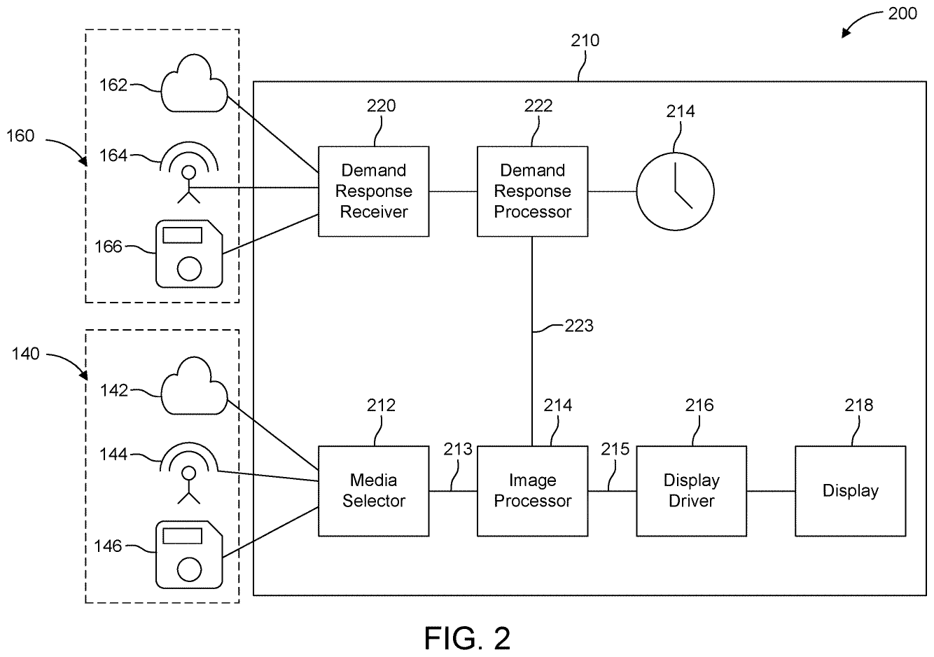

FIG. 1 is a system diagram illustrating an example of a video system 100 according to an embodiment of the present principles. The video system includes an end-user device, exemplified by a TV, 110 according to the present principles, whose operation is discussed in more detail in conjunction with FIG. 2. The TV 110 receives original content 120 through content distribution service 130 as video content delivery 140. Video content delivery 140 can for example include one or more of streaming video 142, terrestrial broadcast video 144, or non-transient media 146, e.g., as a file, Blu-ray disc, digital video disc (DVD), hard drive, memory stick, digital video recorder (DVR), etc.

As is well-known in the art, the original content 120 can be modified using conventional processes for content distribution service 130 to produce the necessary form of video content delivery 140. In some cases, the formatting of the original content 120 is altered, e.g., by cropping and/or changing the aspect ratio of the video image, or by augmenting the video image, e.g., with graphic overlays and/or advertisements. In many cases, the video content 120 is compressed, typically by encoding using a standard codec, for efficient transmission by service 130, in which case video content delivery 140 might be an encoded bitstream requiring decoding by the TV 110 to present the encoded video images. For some forms of content distribution service 130, multiple versions of the content are prepared, e.g., at different resolutions and/or compression to different bitrates (e.g., to supply bitrate ladders), to effectively supply streaming video 142 while adapting to network conditions that could be dynamic and differ among users (not shown, but effectively additional instances of TV 110).

Additionally, TV 110 has communication with power utility management service 150, which provides demand response information 152, of which “demand response (DR) signals” 160 are representative as provided to TV 110. DR signals 160 can be provided via the internet 162, as a wireless transmission 164, as a data file 166, or any other suitable way. In some embodiments, DR signals 160 include a transition and/or current state of a DR condition, e.g., start DR event, DR event in progress, end of DR event, or no DR event in progress. In some embodiments, DR signals 160 include a schedule for when DR events are to occur, e.g., “tomorrow from 4:00 μm to 6:00 μm local time”. In some embodiments, DR signals 160 include pricing for energy, whether current pricing or a schedule of prices, e.g., for the next 24 hours. In some embodiments, DR signals 160 include information describing expected energy supply, expected energy demand, or the margin between the two, whether as a differential energy value or as a percentage. The cases where DR signals include pricing or supply and demand information leave it up to devices, such as TV 110, to determine the conditions during which the device reacts to the DR signals 160 and curtails power use. Whether and to what degree TV 110 exercises curtailment given DR signals 160 can be predetermined as a matter of design, or could be adjusted remotely as a way to update policy, or could be exposed through a user interface as a user setting, allowing the user to establish the current policy under which the device operates.

FIG. 2 illustrates a block diagram 200 for one example embodiment an end-user device 210 according to the present principles, such as the end-user device 110 in FIG. 1. In the non-limitative example, the end-user device is a TV in which conventional media selector 212 is configured to switch among a plurality of video sources and deliver a selected input video signal 213 to image processor 214. Image processor 214 accepts selected video signal 213 and transforms it to produce display video signal 215 for use by display driver 216. Display driver 216 produces the correct set of voltages, currents, clocks, and signals necessary for display 218 to present the video images represented by display video signal 215.

By way of example, media selector 212 can include a High-Definition Media Interface (HDMI) input port that can accept video from a disc (e.g., DVD or Blu-ray disc) files as non-transient media 146. Likewise, media selector 212 can include a USB port that can accept a memory device containing non-transient media 146 media files. Media selector 212 can include a tuner, for example one configured to receive ATSC 1.0 and/or ATSC 3.0 signals, to be tuned to an appropriate television station and to extract an appropriate program such as terrestrial broadcast 144. Media selector 212 can include a network interface, whether wired or wireless, and one or more applications providing access to streaming content through a network to access media such as streaming video 142. In the unusual case where end-user device 210 has only one video input interface (e.g., a single HDMI port), then media selector 212 is optional and selected video signal 213 could come directly from the sole video input.

Image processor 214 is configured to prepare the selected video 213 for use by display driver 216.

In a conventional TV, an image processor is configured to transform a video signal from a standardized video interchange representation (e.g., based on signal standards ITU-R Rec BT.709 or ITU-R Rec BT.2020) to an internal video representation suitable for use by the TV's display driver. There are multiple kinds of transformations that are handled by the image processor.

In some cases, the image processor 214 adapts the resolution of the selected video to the native resolution of the display so that the display driver can operate on a strictly one-to-one basis. Consider for example, a native resolution of the display being 1280×720. An image processor might accept video signals at any of several resolutions (e.g., 640×480, 1280×720, 1920×1080). To adapt these resolutions to the native resolution of this display, the image processor might transform the resolution of the incoming video signal with an upward scaling (e.g., for 640×480) or downward scaling (e.g., for 1920×1080), or leave the resolution unchanged with a unity scaling (for 1280×720). Cropping, pillar-boxing, or letter-boxing might also be a part of resolution transforms, e.g., where a video image having a first aspect ratio is mapped into display having a different aspect ratio, that either results in filling the screen top to bottom but losing the some of the right and left edges of the image (cropping), or retaining the original aspect ratio by filling the screen from side-to-side but not filling the screen from top to bottom resulting in black bars above and below the image (letter-boxing).

In the example of a 640×480 incoming video signal being upscaled to map into a 1280×720 display, a scale factor of 2 will fill the screen side-to-side with the image (640×2=1280), but the top and bottom of the image will be cropped (480×2=960, greater than the display height of 720); alternatively, a scale factor of 3/2 will fill the screen top-to-bottom with the image (480×3/2=720), but the image won't fill the screen horizontally (640×3/2=960, less than the display width of 1280), so to either side of the image, a black bar is placed, i.e., pillar-boxing (each (1280−960)/2=160 pixels wide).

In some cases, an image processor adapts a video signal from a color difference format to a red, green, blue (RGB) additive color format. Color difference representations are a class of color space where the signal representing brightness is isolated from signals representing opposition colors red-green and yellow-blue. This can allow for a more efficient, compact representation of color images that is also well-suited to further compression, but that is transformed into an RGB format for delivery to the display driver for presentation on the display. The image processor is configured to perform the appropriate transform the video color values to the form needed by the display and expected by the display driver.

Further, the color primaries produced by the display and the physical electro-optical transfer functions of each of those primaries (i.e., what voltages, currents, or code values produce how much light), are as much a matter of design choice as is the native resolution: All are determined by physical aspects of the display that are set at the time the display is manufactured.

The image processor might accept video signals having any of several, typically standardized, color encodings and/or transfer functions (e.g., electro-optical transfer functions), while the display driver will operate with a single, particular color encoding and a single, particular transfer function, which are typically proprietary and largely determined by the display. All of which affects the transforms which the image processor is required to provide.

According to the present principles, the image processor 214 has a first, conventional mode, in which the selected video 213 is prepared as first display video signal 215 for use by display driver 216 operation. In this first mode, image processor 214 can operate much the same as image processors of the prior art and first display video signal 215 would be comparable. However, the image processor 214 has the ability to transition to a second mode of operation, for example in the circumstance of reacting to a DR request, in which the selected video signal 213 undergoes a different transformation, resulting in a second display video signal 215 for which the expected power consumption by display 218 is reduced.

DR receiver 220 is configured to receive DR signals 160 from at least one source. In some embodiments, DR receiver 220 includes a connection to the internet and is configured to retrieve or accept DR signals 162 from a remote server (e.g., one provided by the power utility management 150 in FIG. 1). In some embodiments, DR receiver 220 might include a wireless receiver, e.g., for Wi-Fi, terrestrial television broadcast, paging, Bluetooth™, or cellular services, and is configured to receive information 164 by wireless communication. In some configurations, DR receiver 220 includes a file-based interface and is configured to access DR signals file 166 at least occasionally, to keep abreast of updates. In some configurations, the DR receiver 220 includes an implementation of a virtual end node (VEN) in accordance with OpenADR as specified in the publicly available specification (PAS) published by the International Electrotechnical Commission (IEC) as IEC/PAS 62746-10-1, or similar protocols, to receive information 160 as the signals described therein from grid and/or market operators (such as power utility management 150 in FIG. 1) for managing customer energy resources, particularly load.

DR signals 160 received by DR receiver 220 are communicated to DR processor 222, which determines the current DR status, and provides DR event signal 223 to image processor 214, which indicates whether a DR event is in progress. In some embodiments, DR event signal 223 can indicate a degree (e.g., graduations of severity) of a DR event in progress.

In some embodiments within which DR signals include a schedule, DR processor 222 employs a local time of day clock 222 or a remote time service (not shown) to determine the current status based on the schedule.

In some embodiments, where DR signals 160 include energy pricing information, DR processor 222 determines a lower threshold price, above which the DR event signal 223 is active. In some such embodiments, the DR processor 222 may determine severity of the event. For example, the DR processor may further determine a second upper threshold price, above which a DR event is most severe, wherein the degree indicated by the DR event signal 223 is based on the current status energy pricing and the two thresholds: No DR event when the current price is below the lower threshold, a most severe DR event when the current price is at or above the upper threshold price, and a DR event of a proportionally lesser severity when the current price is between the lower and upper threshold prices. This may for example be computed by EQ. 1 in which the current price is indicated by price, the lower threshold by thresholdₗ and the upper threshold by thresholdᵤ:

$$severity ( price ) = \{ \begin{matrix}0 : & price < {threshold}_{l} \\ 1 : & price \geq {threshold}_{u} \\ \frac{( price - {threshold}_{l} )}{( {threshold}_{u} - {threshold}_{l} )} : & otherwise\end{matrix} \} \qquad EQ . 1$$

In some embodiments, where DR signals 160 include information about the amount of energy available and energy demanded, or about the margin therebetween, DR processor 222 can determine a first warning threshold margin, below which the DR event signal 223 is active. In some such embodiments, the DR processor 222 may determine severity of the event. For example, the DR processor may further determine a second critical threshold margin, below which a DR event is most severe, wherein the degree indicated by the DR event signal 223 is based on the current status energy availability and energy demanded, or the margin there between, and the two thresholds: No DR event when the current margin is greater than warning threshold margin, threshold_{w}, a most severe DR event when the current margin is lower than the critical threshold, threshold_{c}, margin, and a DR event of a proportionally increased severity when the current margin, margin, is between the warning and critical threshold margins, for example as computed by EQS. 2 and 3:

$$margin = \frac{{energy\_available}_{current} - {energy\_demanded}_{current}}{{energy\_available}_{current}} \qquad EQ . 2$$

$$severity ( margin ) = \{ \begin{matrix}0 : & margin > {threshold}_{w} \\ 1 : & margin \leq {threshold}_{c} \\ \frac{( {threshold}_{w} - margin )}{( {threshold}_{w} - {threshold}_{c} )} : & otherwise\end{matrix} \} \qquad EQ . 3$$

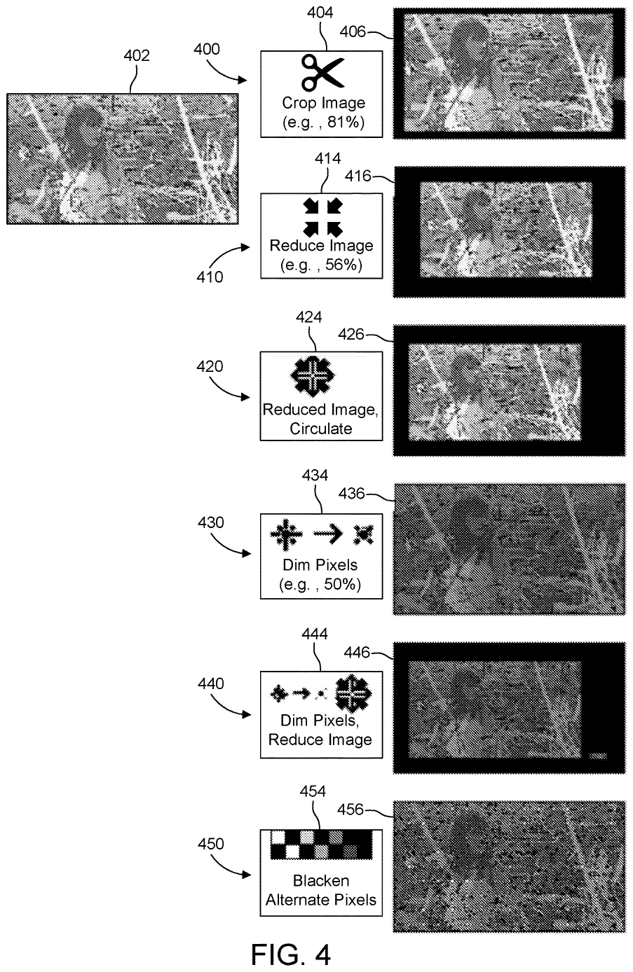

In response to DR event signal 223 indicating that a DR event is not in progress, image processor 214 performs in conventional ways, such as those described above. However, in response to a DR event signal 223 indicating that a DR event is in progress, image processor 214 reduces the scale and/or brightness of images in display video signal 215, as will be described in more detail in conjunction with FIG. 4.

Note that the equations EQ. 1 for severity (price) and EQ. 3 for severity (margin) are clamped to the closed range [0,1] and strictly linear within the range, however other equations that are merely monotonic, rather than strictly linear, can be used. Some embodiments may determine severity in a non-linear way, thus reaching higher degrees of severity (i.e., approaching 1) earlier in the function (e.g., at a lower price, or while the margin is greater). Also, whether or not the determination of severity is linear in comparison to price or margin can be independent of how image processor 214 reacts to event signal 223, and how that reaction affects power consumption of the system-a non-linear computation of severity might be unnecessary if the energy savings resulting from the reaction of image processor 214 is already at or above a desired level. The two, the computation of severity and the reaction of image processor 214, can be examined collectively to determine whether the collection response represents the design intent.

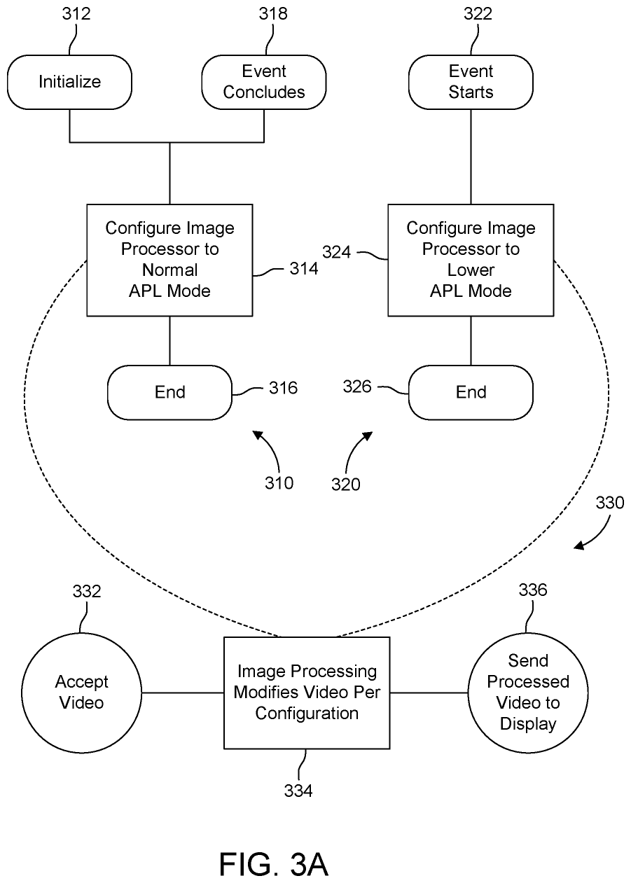

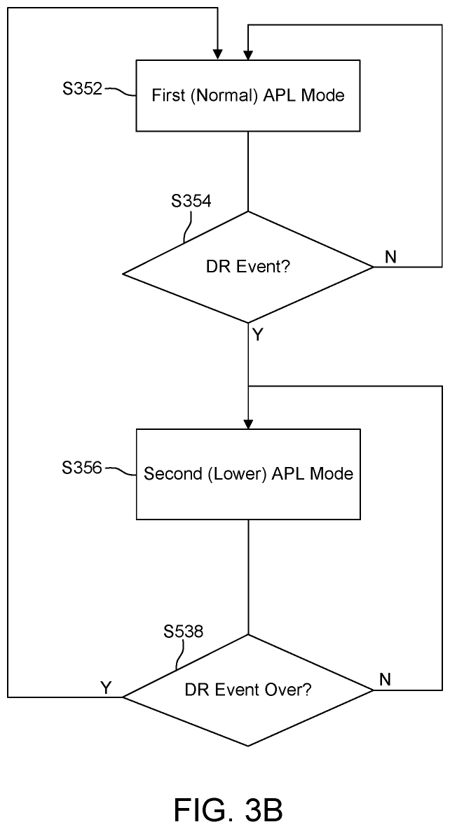

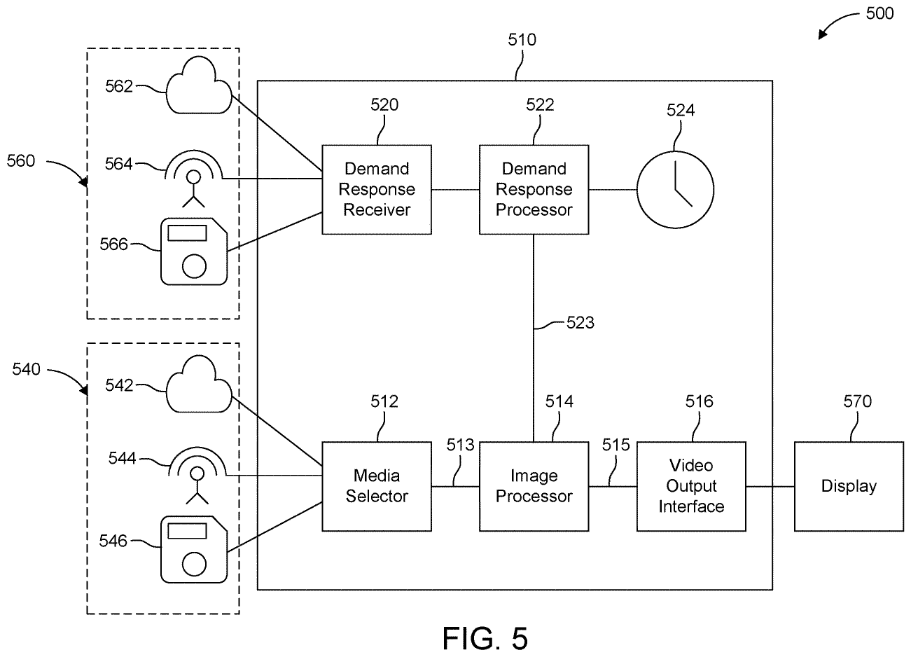

FIG. 3A illustrates flow charts of three related methods 310, 320, and 330 according to the present principles. Upon initialization 312, a DR processor (e.g., 222 of FIG. 2, or 522 of FIG. 5) performs initialization process 310 and configures image processing step S334 to a first (e.g., conventional) APL mode at step S314. Communication of this normal APL mode configuration from step S314 to image processing step S334 is illustrated as the dotted line running between step S314 and step S334. Image processor 214 in FIG. 2 is one embodiment suitable for performing image processing step S334, in which case, normal APL mode corresponds to conventional operation of the image processor in a television, preparing input video for the display driver. The initialization process 310 concludes at 316.

DR process 320 begins when a DR event is detected by a DR processor (e.g., 222 of FIG. 2, or 522 of FIG. 5). DR process 320 configures image processing step S334 to a reduced APL mode at step S324. Communication of this reduced APL mode configuration from step 324 to image processing step S334 is illustrated as the dotted line running between step S324 and step S334. DR process 320 ends at 326.

Note that the exit of process 320 at 326 does not represent the end of the DR event, nor a device's response to a DR event that has occurred. Rather, when the DR processor (e.g., 222) detects that the DR event has ended or that there is no DR event, then initialization process is initiated at 318, and otherwise operates as described above.

While operating, an image processor according to the present principles (e.g., 214 in FIG. 2 or 514 in FIG. 5) performs image pipeline process 330 which includes accepting 332 an input video, such as selected video signal 213 as a sole input, or as selected by a media selector 212. In image processing step S334, the input video is modified by the image processor in accordance with the current mode, such as the normal APL mode set at 314 or reduced APL mode set at 324. The modified video produced at step S334 is sent to a display (e.g., 218 in FIG. 2, or 570 in FIG. 5) by way of a display interface (e.g., display driver 216 in FIG. 2, or video output interface 516 in FIG. 5).

FIG. 3B illustrates the flowcharts of FIG. 3A in a different way. In step S352, an end-user device performs in the first, normal APL mode (i.e., without particular power saving). In step S534, it is determined whether a DR event is ongoing. In case it is not, the method returns to step S352; in case it is, the method continues in step S536 in which the end-user device performs in the second, lower APL mode (i.e., with a goal of saving energy). In step S538, it is determined if the DR event is over. In case it is not, the method returns to step S356; in case it is, the method returns to step S536 and the first APL mode.

In some embodiments, rather than having only two configurations (normal APL mode as set at 314 and reduced APL mode as set at 324), image processing step S334 may be responsive to a finer division of the continuum between those two modes. For example, the switch in behavior at step S334, from a normal APL mode to a lower (e.g., reduced) APL mode, following execution of DR process 320, might not be an instantaneous change, affecting one frame not at all but modifying the next frame in the full degree. Instead, such embodiments may gradually transition between the modes, for example taking up to 15 minutes before video frames are being fully affected by the reduced APL mode. Ideally, the transitions between normal and reduced APL modes goes unnoticed by a viewer watching the display. Implementations of such gradual transitions can be achieved by temporal filtering of one or more, ideally all, of the parameters set by the normal and reduced APL modes.

In an embodiment, a combined initialization and DR response process (not shown) performs temporal filtering to determine a current effective mode, based on the temporal filtering and/or severity indicated by DR event information and determined by DR processor (e.g., 222 in FIG. 2, or 522 in FIG. 5).

FIG. 4 illustrates a variety of examples (rows 400, 410, 420, 430, 440, 450) of power-saving image processing according to the present principles. The example image processing can be performed by an image processor (e.g., 214 in FIG. 2, or 514 in FIG. 5) while configured in a lower (i.e., reduced) APL mode, e.g., following the performance of step 324 in FIG. 3A or in step S356 in FIG. 3B. In these examples, while input image 402 is shown at the same size and aspect ratio as resulting images 406, 416, 426, 436, 446, and 456, this does not imply that the input images and the output images need be at the same resolution and/or aspect ratio, though they can be. As already described, the resolution of the overall image represented by display video signal 215 output by the image processor 214 can be whatever is appropriate to the next stage. In the case of the embodiment in FIG. 2, this is determined by the resolution of display 218 and the corresponding resolution of the input of display driver 216. In cases where the input image is supplied at a resolution different than that of the output image, that different resolution is covered, but not illustrated by FIG. 4. Likewise, for cases where the input image is supplied at an aspect ratio different than that of the output image, that different aspect ratio is covered, but not illustrated by FIG. 4.

Row 400 shows a first example embodiment of image processing step S334 in which image 402 from an input video (e.g., selected video signal 213) undergoes cropping 404, resulting in output image 406 (e.g., of display video signal 215) in which the remaining image portion 408a of the cropped image sits within a black field 408b. Cropping of this kind can remove up to 10% of the width and/or height of an image (10% overall from the top and bottom or 10% overall from the right and left edges) without intruding on the “action safe” area of the image, when produced according to the Society of Motion Picture and Television Engineers (SMPTE) in their recommended practice, SMPTE RP 0218-2009. Given example cropping process 404, which keeps 90% of the original width and 90% of the original height of the image, the result is 81% of the pixels remain in image portion 408a, and a likewise 81% scaled APL for the resulting image 406.

Row 410 shows a second example embodiment of image processing step S334 in which image 412 from an input video (e.g., selected video signal 213) undergoes resolution reduction 414, resulting in output image 416 (e.g., of display video signal 215) in which the reduced resolution portion 418a sits within a black field 418b. This scaling technique can be use alone or in conjunction with the cropping technique above, which combination carries the advantage that the subject, typically more important than the periphery of the image, is not subject to as much reduction in size as is the final image.

Row 420 shows a third example embodiment of image processing step S334 in which input image 402 from an input video undergoes resolution reduction and circulation 424, resulting in output image 426 in which the reduced resolution portion 428a circulates (i.e., moves around) within a black field 428b, which might be used to minimize the appearance of burn-in caused by prolonged use of the reduced APL mode shown in row 410.

Row 430 shows a fourth example embodiment of image processing step S334 in which input image 402 from an input video undergoes a luminance reduction 434, in this case a linear dimming of all pixels by 50%, resulting in output image 436 in which the reduced luminance image 438a fills the output image 436. Alternative implementations of such an embodiment can use different function for the luminance reduction—for example the allowed peak brightness of the image might stay the same and a non-linear gamma curve applied, darkening intermediate value pixels, resulting in an overall reduced APL. Another alteration could combine reduced peak luminance with the gamma curve to achieve the reduced APL. In some embodiments of this example, the input image might be a high peak brightness, high dynamic range (HDR) image, and the output image is a lower peak brightness, standard dynamic range (SDR) image.

Row 440 shows a fifth example embodiment of image processing step S334 in which input image 402 from an input video undergoes a luminance and resolution reduction and circulation 444, resulting in output image 446 in which the reduced luminance and resolution portion 448a circulates within a black field 448b. Such a combination obtains the advantage of the product of both APL reductions (e.g., 28% as the product of 56% from image reduction process 414, 50% from luminance reduction process 434) if taken individually.

Row 450 shows a sixth example embodiment of image processing step S334 in which input image 402 from an input video undergoes blackening process 454 affecting of some fraction of its pixels, resulting in output image 456. The particular process is well-suited when providing video to an OLED display, where a single pixel being turned black contributes to a power savings. However, it is less suitable for use by a broadcaster, since a blackening of a single pixel is not reliably reproduced as fully black when passed through encoding/decoding processes. Patterns suitable for such blackening can include alternate rows, or alternate columns, or the quincunx (checkerboard) pattern as shown in row 450. Where the fraction of pixels being blacked out is significant (e.g., more than one in four), an amount of lowpass spatial filtering (e.g., blur) should be applied before the blackening, to minimize aliasing that might occur, particularly with patterns such as alternate columns or alternate rows. This blackening is also well-suited to high resolution displays, where individual pixels are not resolved at normal viewing distances, and may be used with other techniques (e.g., blacken using process 454, then scale using process 414, or vice versa). This technique 450 works well when the resolution of the resulting image 456 matches that of the display 218/570, with no intervening scaling.

In some embodiments, an image processor (e.g., 214 in FIG. 2, or 514 in FIG. 5) receives a selected video signal representative of a standard dynamic range (SDR) image accompanied by corresponding SL-HDR1 metadata as specified in ETSI TS 103 433-1 “High-Performance Single Layer High Dynamic Range (HDR) System for use in Consumer Electronics devices; Part 1: Directly Standard Dynamic Range (SDR) Compatible HDR System (SL-HDR1)” as published by both the European Telecommunications Standards Institute (ETSI) and the European Broadcasting Union (EBU). In normal APL mode, where the display is HDR-capable, the image processor applies the corresponding SL-HDR1 metadata to the image to reconstruct an HDR version of the image for presentation in HDR, as a preferred presentation. However, in response to an DR event, in the reduced APL mode, the image processor can forego the reconstruction to HDR and leave the image in SDR. In an alternative embodiment, even during an DR event in the reduced APL mode, the image processor can apply the SL-HDR1 metadata and reconstruct the HDR image, but also apply a resolution reduction to mitigate an expected increase in APL that would otherwise be seen due to the HDR. In still another alternative embodiment, in the reduced APL mode, the image processor can apply the SL-HDR1 metadata and reconstruct the HDR image, but applying a display adaptation tuning (described in Annex E of the ETSI standard, wherein L_{pdisp} is the maximum luminance of the HDR-capable presentation display) but using a derated value instead of the actual maximum luminance of the display (e.g., 218 in FIG. 2, or 518 in FIG. 5), thereby reducing the peak brightness and the APL of the resulting image while in the reduced APL mode.

Other forms of HDR metadata, whether static or dynamic, can be employed to guide modifications to peak and/or overall brightness, and conversions among SDR and HDR or between different HDR presentations, though SL-HDR1 is particularly well-suited to these operations. Other examples include Dolby Vision metadata, as specified in ETSI TS 103 572; HDR+ metadata, specified in SMPTE ST 2094-40 as published by the Society of Motion Picture and Television Engineers.

Still other forms of HDR can be appropriately manipulated. The Hybrid-Log Gamma (HLG) encoding specified in ITU-R Rec. BT.2100, as published by the International Telecommunications Union, is accompanied by formulae for rendering an HLG video signal to a target display having a nominal peak luminance L_{w}. During a DR event, the reduced APL mode can be implemented by substituting a derated value for L_{w}, thereby reducing overall brightness, including reducing the peak brightness, yet still present an HDR image, but one having a lower APL.

FIG. 5 illustrates a block diagram 500 of a video processing system comprising video source device 510 of the present principles, which could be an STB, AVR, or professional equipment for use in television broadcast station or distribution facility. In most respects, elements of video source device 510 operate similarly to their counterparts in television 210 of FIG. 2. A primary difference is that when television 210 produces display video signal 215, it is supplied to an internal display driver 216 and corresponding display 218, whereas when video source device 510 produces display video signal 515, it is supplied to video output interface 516 which connects to an external display 570. The display driver for external display 570 would be internal to display 570 and display 570 may have its own conventional image processor.

Otherwise, the modules of video source device 510 can be functionally equivalent to their corresponding modules within TV 210: Media selector 512 to media selector 212; selected video signal 513 to 215; demand response receiver 520 to 220; demand response processor 522 and clock 524 to 222 and 524; DR event signal 523 to 223; video content delivery 540 with types 542, 544, 546 to 140, 142, 144, and 146 respectively. DR response signals 560, with kinds 562, 564, 566 to 160, 162, 164, and 166 respectively.

Accordingly, the processes performed by video source device 510 are largely equivalent to those performed in television 210, the exceptions stemming from display 570 being external to video source device 510, rather than internal, as with display driver 218 and display 220 of television 210. In the case of television 210, the video format of display driver 216 matches that of internal display 220, and this is predetermined so that image processor 214 behaves accordingly, e.g., always scaling video to a resolution to match the display driver 216 inputs.

In some embodiments of video source device 510, the output video format of video output interface 516 is fixed, and thus predetermined for image processor 514. In such embodiments, image processor 514 operates in the same way as image processor 214.

In some embodiments of video source device 510, the output video format of video output interface 516 is set via user interface (not shown), and thus determined for image processor 514. In such embodiments, after such a setting through the user interface, image processor 514 operates in the same way as image processor 214.

In some embodiments of video source device 510 the output format of video output interface 516 is dependent on a negotiation between video output interface 516 and external display 570, after which, image processor 514 is responsive to the negotiated output format, for example causing display video signal 515 to match the negotiated video resolution. In some such embodiments, the negotiations are as specified in various editions of CTA 861 (the current being CTA-861-H), published by the Consumer Technology Association, which have been adopted in the High-Definition Multimedia Interface (HDMI) and DisplayPort standards and widely implemented for video and computer displays. In such embodiments, after such negotiation, image processor 514 operates in the same way as image processor 214.

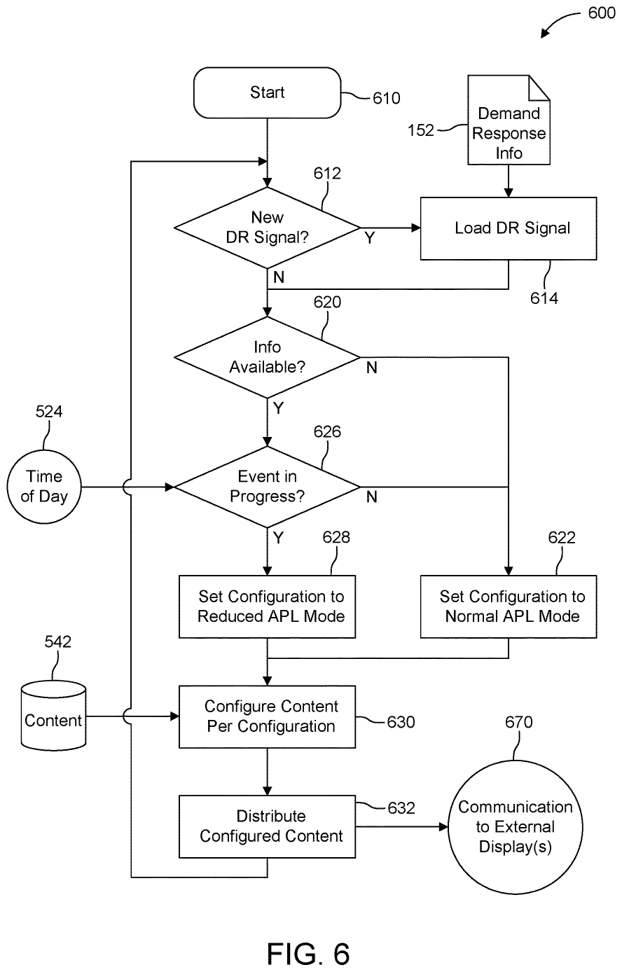

FIG. 6 is a flowchart for a method of video processing 600 performed by video source device 510 according to the present principles. The method starts at step S610 and continues to step S612 where a check is made for the availability of a new DR signal (as an embodiment of 560) representative of demand response information 152, which if available, is loaded as DR signal at step S614.

In case a new DR signal was available, processing proceeds, in step S620, to check whether a DR signal is available and, in step S626, whether a DR event is in progress (which check may interrogate the time-of-day clock 524). If either check fails (i.e., no DR signal available at step S620 or no DR event in progress at step S626), then processing continues at step S622 to set the configuration of image processor 514 to normal APL mode. If both checks pass (i.e., a DR signal is available at step S620 and there is a DR event in progress at step S626), the processing continues at step S628 to set the configuration of image processor 514 to reduced APL mode.

From either step S622 or step S628, processing continues at step S630 where video content delivery 540 (e.g., 542) is the selected video signal 513 provided to image processor 514 and is processed by the image processor at step S630 to produce display video signal 515 which is distributed at step S632 by video output interface 516 as the communication to external display(s) 670.

In some embodiments, communication to external display(s) 670 connects to a single display 570 and such would be the case for HDMI or DisplayPort implementations of video output interface 516 as these rely on a one-on-one negotiation.

In some embodiments, such as a video source device 510 used in a professional broadcast facility (not shown), communication to external display(s) 670 supplies the display video signal 515 to a video output interface 516 that includes high fanout distribution, such as terrestrial broadcast. The present principles are well suited to terrestrial television broadcast because, like electric utility distribution, terrestrial television broadcast is localized by region. Where a particular electric utility is experiencing high demand, approaching its available production capacity, any other electric utility in the vicinity is likely to be experiencing similar conditions, e.g., on a hot summer day where in addition to a normal day's load, all the air conditioning systems are seeing heavy use. A television broadcaster in that region effectively controls the instantaneous power demand from those televisions tuned to the broadcaster's programming. Collectively, all of the television broadcasters control the instantaneous power demand from all televisions tuned to broadcast programming, on a pro rata basis based on the market share of their programming. This presents each broadcaster with an opportunity to be a single point of control to mitigate power demand from all the TVs of their instantaneous audience.

From the foregoing, it should be clear that many alternative adjustments to peak brightness, other image brightnesses, and image size reduction can be employed separately or in combination, to selectively reduce the APL of the display video signal 215/515 output by the image processor 214/514 (respectively), yet fall within the scope of the present principles whether operating with an internal display 218 as in television 210 or in conjunction with an external display 570 (or displays 670) as in video source device 510.

In those exemplary embodiments where the scale of the image from selected video signal 213/513 is reduced based on at least DR event signal 223/523 indicating that a DR event is in progress, then the reduction in scale is relative the image size within the display video signal 215/515 that would result were signal 223/523 to indicate that a DR event is not in progress. The image size when the DR event is not in progress is a screen-filling size for the display 218/570, except when the aspect ratios of the original image in video signal 213/513 and the display 218 (or setting of video output interface 516) do not match and either pillar-boxing or letter-boxing is employed by image processor 214/514. When the aspect ratio of the image and display/setting are the same, then the aspect ratio of the reduced size image is also the same.

In case the aspect ratios of the screen and the image are different, and pillar-boxing or letter-boxing is employed by image processor 214/514 to maintain the original aspect ratio of the image, then the reduced-size image maintains the original image aspect ratio, too. However, for the circumstance that the aspect ratios of the screen and the original image are different, and the image processor 214/514 is configured to fill the screen without using pillar-boxing or letter-boxing, then either excess image is cropped or the image is anamorphically scaled (i.e., the scale factor for the horizontal and vertical axes are not equal), then the aspect ratio of the reduced image in display video signal 515 can be different whether a DR event is in progress: When not in progress, the screen-filling image produced by the image processor 214/514 is either cropped or anamorphically scaled, so its aspect ratio won't match that of the original image in selected video signal 213/513, but when in progress, the reduced size image needn't be so cropped or anamorphically scaled, and its aspect ratio will be different and will be closer to or match the aspect ratio of the original image.

For example, consider a selected video signal 213 having a full screen image of resolution 1920×1080 in a television 210 having a display 218 with native resolution 1280×960, the image and display sharing a common aspect ratio. With DR event signal 223 indicating that a DR event is not in progress, image processor 214 will scale the selected video signal 213 by a uniform ⅔ in each linear dimension, such that the full-screen 1920×1080 image is mapped into a full-screen 1280×960 image, matching the resolution of display 218. This is consistent conventional behavior by an image processor of the prior art. However, with DR event signal 223 indicating that a DR event is in progress, a different smaller scaling is applied, for example, a uniform ⅓ in each linear dimension, which is a ½ “additional scale reduction factor” over that used when a DR event is not in progress. In this case, the image is mapped to be 640×360, which is much smaller than the full-screen 1280×960 physical resolution of the display 218 and the matching display video signal 215 into which this smaller image is imbedded. The remaining pixels (75%) within display video signal 215 are set to black. The 75% is because the image was reduced to be smaller than the display by the additional scale reduction factor (½), which when squared (½×½=¼) determines the area ratio (¼=25%) occupied by the image. The remaining pixels (100%−25%=75%) are the ones set to black.

Note that the choice of ½ as the additional scale reduction factor is a design choice that does not affect the present principles, provided the additional scale reduction factor is in the open range (0, 1), i.e., not include 0 or 1.

For an ideal display, i.e., one which consumes energy exactly equal to the radiometric flux of the photons forming the displayed image, the percentage energy savings due to the additional scale reduction factor is exactly the portion of pixels set to black (for the present example, 75% or EQ. 4 for the case of an image displayed without cropping). This fractional energy savings holds even for the portion representing a linearly lossy display, i.e., one which consumes energy exactly proportional to the radiometric flux of the photons forming the displayed image (where the proportion is >1.0).

$${fractional\_savings}_{ideal} = 1 - {( additional\_scale \_reduction \_factor )}^{2} \qquad EQ . 4$$

If there are non-proportional portions of a display's energy consumption, these will alter this relationship. For example, if a portion of a television's power consumption is independent of the video APL but the remainder is proportional to the APL, then the fractional energy savings is modeled by EQ. 5 in which energy_{APL} is the amount of energy consumed to display an image having an APL of APL before the additional scale reduction factor is applied. When energy constant is small relative to energy_{APL}, then fractional_savingsₙₑₜ approaches fractional_savings_{ideal}.

$${fractional\_savings}_{net} = \frac{( {energy}_{constant} + {energy}_{APL} \times {fractional\_savings}_{ideal} )}{( {energy}_{constant} + {energy}_{APL} )} \qquad EQ . 5$$

If there is a portion of the energy consumed that corresponds to non-linear energy losses (e.g., a hypothetical power supply whose efficiency varies with APL, or varies by historic APL and/or environmental factors due to cumulative heating), then a mathematical model of fractional energy savings will depend on the specific physics involved.

Anticipation of potential energy consumption reductions that might accrue due to a broadcaster applying video source device 510 to their distribution, an aggregate fractional energy savings can be determined by correlating intervals of APL with corresponding intervals of aggregate energy consumption readings from the utility company, to determine what fraction of the aggregate energy consumption is due to the televisions of the audience tuned live to the broadcaster. Such a determination could serve to drive policy decisions regarding use of the present principles by content distributors.

It is not required that image processor 214/514 operate bimodally, i.e., normal APL mode and a single reduced APL mode. In some embodiments, the value of DR event signal 223 may report a temporally smoothed transition, rather than the one-of-two discrete states of a DR event is not in progress (e.g., 0) or a DR event is in progress (e.g., 1). For example, the transition between the two discrete states could be smoothed by use of a temporal filter or ramping function. In such embodiments, the smoothed signal might be treated in the same way as described for severity, in the closed range of [0, 1], where zero represents “a DR event is not in progress” and a non-zero value represents “a DR event is, or recently was, in progress.” Smoothing can also be applied to otherwise discontinuous changes in severity.

There can be two advantages to smoothing a DR event signal 223. First, a viewer of the display 218/570 will not observe a sudden radical change to the image displayed. Ideally, the transition to the reduced APL mode is made slowly enough to escape noticed. Second, the power grid will not experience a sudden change in load, rather the onset of reduced APL mode or the return to normal APL mode is spread out over many minutes.

Fixed-rate smoothing can be achieved by applying a periodic, fixed-magnitude signal change δ to the current value of DR_signal_{smoothed} until the value of DR_signal, i.e., DR event signal 223 determined by demand response processor 222/522, is reached. One example embodiment of such a smoothing function is presented in EQ. 6, which updates DR_signal_{smoothed} at each uniform time increment Δt.

$${DR\_signal}_{Δ} ( t ) = DR\_signal ( t ) - {DR\_signal}_{smoothed} ( t ) \qquad EQ . 6$$

$${DR\_signal}_{smoothed} ( t + Δ t ) = {DR\_signal}_{smoothed} ( t ) + \{ \begin{matrix}0 : & {DR\_signal}_{Δ} ( t ) = 0 \\ Minimum ( δ , {DR\_signal}_{Δ} ) : & {DR\_signal}_{Δ} ( t ) > 0 \\ Maximum ( - δ , {DR\_signal}_{Δ} ) : & {DR\_signal}_{Δ} ( t ) < 0\end{matrix} \}$$

The fixed-magnitude signal change δ and time increment Δt can be chosen such that the difference in display video signal 215/515 when DR_signal_{smoothed} changes by δ is unnoticeable, even when applied at intervals of Δt. By way of example, consider Δt to be 1/30 of a second and that the selected video signal 213/513 has a frame rate of 30 frames per second. The smoothed DR event signal will approach the appropriate value by, at most, δ per frame. If δ is chosen so that image processor 214/514 changes its image size reduction for reduced APL mode behavior by at most 2 pixels (one at each of the left and right edges) then a 50% reduction in a display video signal 215/515 image having a full-screen width of 1280 would take (1280 pixels×50%/2 pixels per reduction×( 1/30) seconds=10⅔ seconds for the onset of reduced APL mode to complete, which may be quick enough to be noticeable. If Δt were increased to 1 second, then the same transition would take 320 seconds, or 5⅓ minutes, which would be slow enough to remain unnoticed, yet fast enough to be useful for power utility management 150.

It is not required that image processor 214/514 change its operating mode immediately, e.g., switching between the normal APL mode and a reduced APL mode as soon as DR event signal 223 signals a DR event is or is not in progress. In some embodiments, such a transition can be briefly held off until the input signal is such that the change in processing would be less noticeable. For example, the transition in operating mode of the image process might be held off until the video is black: A common practice in video production that is applied when changing video sources (e.g., between a program and a commercial, or between commercials) is to first fade to black, which would result in the mode change being hidden until the next video segment appears. For another example, the transition can be held until a scene change is detected, which would include not only such fade-to-black events, but also hard cuts from one shot to another. Scene-change detection is known in the art. Gradual cross dissolves from one shot to another would generally not trigger such a detector, nor would that be desirable.

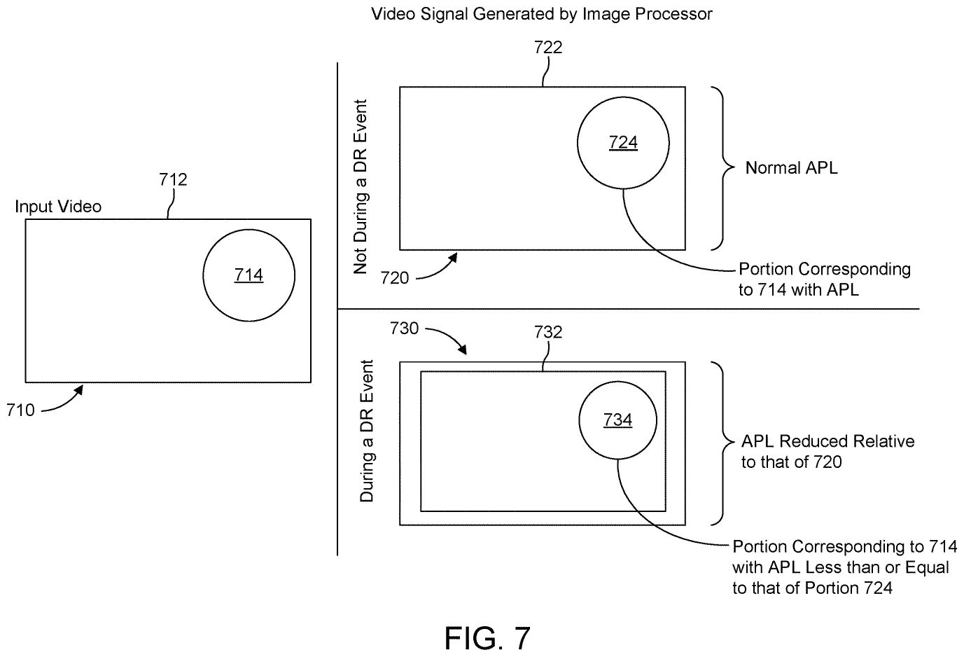

Referring to FIG. 7, input video 710, corresponding to selected video signal 213/513, is shown schematically, comprising image 712 having a portion 714.

Video signal 720 comprises image 722 having portion 724, is based on input video 710, and corresponds to video signal 215/515 when generated by image processor 214/514 operating in normal mode, as when no demand response event is occurring. Video signal 720 has a corresponding APL. Portion 724 corresponds with portion 714 and has a corresponding APL.

Video signal 730 comprises image 732 having portion 734, is also based on input video 710 and corresponds to video signal 215/515 when generated by image processor 214/514 operating during a demand response event. Video signal 730 is the result of image processor 214 employing at least some APL reduction technique, e.g., one or more of the processes (e.g., 404, 414, 424, 434, 444, 454) described in conjunction with FIG. 4. Accordingly, the APL of video signal 730 is less than the APL of video signal 720. In FIG. 7, the illustration of video signal 730 shows, by way of example, the reduced image size process 414 used to produce video signal 416 as shown in FIG. 4. Portion 734 corresponds with portion 714 and has a corresponding APL. This example illustrates that portion 734 need not be the same size in the video signal 730 as portion 724 is within video signal 720, due to scaling of image 732 within the resolution of video 730, though it can be, if an APL reduction technique that does not use image scaling is used. In cases where the image is scaled in this way, but the pixels are not otherwise dimmed, the APLs of portions 724 and 734 may be the same or similar. If techniques other than just scaling are applied (e.g., pixel dimming process 434) then the APL of portion 734 will be less than the APL of portion 724, regardless of whether scaling is applied.

Finally, in some embodiments, the present principles accept input via user interface (not shown) to select a power derating setting. This setting allows a user to express a preference for a display to save energy. Such a preference can be asserted in either of two ways: First, the user preference can modify the DR event signal value issued when a DR event is not in progress, e.g., by establishing a floor below which the DR event signal will not fall. Later, if the power utility calls for a demand response, the DR event signal will rise above this floor value and image processor 214/514 will produce images that result in greater savings. In the alternative, a second method redefines the image processing for normal APL mode operation. In either case, the image processor 214/514 induces an energy savings when the DR event signal 223 indicates that a DR event is not in progress and increases energy savings when DR event signal 223 indicates that a DR event is in progress.

As can be seen, embodiments of the present principles can reduce the energy consumption of video displays when a demand response event is recognized by altering a video signal so that only a portion of the pixels of the display are illuminated than would have been illuminated for the video content absent the demand response event.

As can be seen, embodiments of the present principles can reduce the energy consumption of video displays when a demand response event is recognized by altering a video signal so that pixels of the display are less brightly illuminated than they would have been for the video content absent the demand response event.

As can be seen, embodiments of the present principles can reduce the energy consumption of video displays when a demand response event is recognized by altering a video signal so that both only a portion of the pixels of the display are illuminated than would have been illuminated for the video content absent the demand response event and further pixels of the display representing the image, on average, are less brightly illuminated than those that would have represented the video content absent the demand response event.

As can be seen, embodiments of the present principles can be integrated into a self-contained video display, for example, a television.

As can be seen, embodiments of the present principles can be integrated into a set-top box or plug-in video source, such as an over-the-top (OTT) stick.

As can be seen, embodiments of the present principles can receive demand response information via connection to a network, via wireless transmission, or via file, where the demand response information is a feed independent of any video stream.

As can be seen, embodiments of the present principles can receive demand response information in conjunction with a video stream, where the video stream is received via connection to a network, via wireless transmission, or via file.

As can be seen, embodiments of the present principles can reduce energy usage by an in-use video display when energy demand is excessive, as signaled by electricity prices being high.

As can be seen, embodiments of the present principles can reduce energy usage by an in-use video display in response to a smart home control signal or a user-preference.

As can be seen, embodiments of the present principles can consider the current time of day and/or policies in determining from demand response information received, whether a demand response event is in progress and what degree of reaction will be made to reduce energy consumption by the display.

As can be seen, embodiments of the present principles can, automatically and selectively, reduce the power consumption by video displays for which the energy consumption is dependent in some way upon the video image brightness.

As can be seen, embodiments of the present principles can accept data representative of a request to lower power consumption. In some embodiments, this data may explicitly signal the start and end of intervals when reduced power consumption is requested. In some embodiments, this data may imply intervals during which reduced power consumption is requested, e.g., intervals where the price of power is raised relative to other times, the price of power is above a threshold, or the marginal capacity of the utility service to supply power beyond the current demand is below some absolute value or percentile threshold.

As can be seen, embodiments of the present principles can accept data representative of a request to lower power consumption, in some embodiments, as a signal separate from that of the video content, and in some embodiments, as a signal intermixed with the video content, e.g., as metadata.

As can be seen, embodiments of the present principles can gradually decrease energy consumption by video displays in response to demand response information received, making the transition less noticeable.

As can be seen, embodiments of the present principles can defer reducing energy consumption by video displays in response to demand response information received, until the video content is such as to make the transition less noticeable.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the present principles. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

1. A device comprising:
a receiver configured to receive data indicative of a demand response;
at least one processor configured to:
receive information corresponding to a first video from a video source, and
generate a second video based on the first video, with a selected one of a first mode in which the second video has a first Average Picture Level (APL) and a second mode in which the second video has a second APL less than the first APL when the first APL is non-zero, the first mode being selected at least in response to reception of data indicative of no demand response event in progress, the second mode being selected in response to reception of data indicative of a demand response event in progress and when one of a) a scene change is detected in the first video by the at least one processor, b) an all-black frame is detected in the first video by the at least one processor, and c) a gradual transition to the second mode is completed, otherwise the first mode being selected; and,
a video output configured to provide the second video to a display.

2. The device of claim 1, wherein, in case power consumption of the display is APL-dependent, the second video of the second mode, compared to the second video of the first mode, enables the display to consume less power during a demand response event.

3. The device of claim 1, wherein the video source is one of a plurality of video sources, the device comprising:
a media selector configurable to select the video source from the plurality of video sources.

4-6. (canceled)

7. The device of claim 1, wherein the data indicative of the demand response originates from a power utility and indicates a request to lower power consumption.

8. The device of claim 1, wherein the device is a television set that comprises the display.

9. The device of claim 1, wherein the device is an end-user device functionally connected to the display that is external to the device.

10. The device of claim 1, wherein the device is located at a head-end that streams or broadcasts the information corresponding to the second video to one or more receivers.

11. A method, performed by a device, the method comprising:
receiving data indicative of a demand response;
receiving information corresponding to a first video from a video source;
selecting, from a first mode of generating video from the first video which would produce a first Average Picture Level (APL) and a second mode of generating video from the first video which would produce a second APL less than the first APL when the first APL is non-zero, the first mode being selected at least in response to reception of data indicative of no demand response event in progress, one selected mode, wherein the selected mode is the second mode in response to reception of data indicative of a demand response event in progress and when one of a) a scene change is detected in the first video by the device, b) an all-black frame is detected in the first video by the device, and c) a gradual transition to the second mode is completed, and the first mode otherwise;
generating a second video based on the selected mode; and
providing the second video to a display.

12. The method of claim 11, wherein, in case power consumption of the display is APL-dependent, the second video of the second mode, compared to the second video of the first mode, enables the display to consume less power during a demand response event.

13. The method of claim 11, wherein the video source is one of a plurality of video sources, the method-further comprising selecting the video source from the plurality of video sources.

14-16. (canceled)

17. The method of claim 11, wherein the data indicative of the demand response originates from a power utility and is indicates a request to lower power consumption.

18. The method of claim 11, wherein the device is a television set that comprises the display.

19. The method of claim 11, wherein the device is an end-user device functionally connected to the display that is external to the device.

20. The method of claim 11, wherein the device is located at a head-end that streams or broadcasts the information corresponding to the first video to one or more receivers.

21. A non-transitory computer-readable storage medium storing instructions that, when executed, cause at least one hardware processor perform the method of claim 11.
